(19) United States
(12) Patent Application Publication
(10) Pub. No.: US 2013/0346368 A1
(43) Pub. Date: Dec. 26, 2013

(54) SYSTEM AND METHOD FOR INTEGRATING SOFTWARE FUNCTIONALITIES ON N-LAYER ARCHITECTURE PLATFORM

(71) Applicant: Naveen Chopra, New Delhi (IN)

(72) Inventor: Naveen Chopra, New Delhi (IN)

(21) Appl. No.: 13/978,669

(22) PCT Filed: Dec. 8, 2011
(86) PCT No.: PCT/IB2011/002991

§ 371 Date: Jul. 8, 2013

(30) Foreign Application Priority Data
Dec. 8, 2010 (IN) 2936/DEL/2010

(51) Int. Cl. G06F 17/30

(52) U.S. Cl. CPC G06F 17/30575
USPC 707/634

(57) ABSTRACT

A system and a method for integrating software functionalities in n-layer architecture platform, the method comprising authenticating a session, basic and advanced replication of a master database onto a slave database, fetching the related information from the master database; and updating the slave database.

### FIELD OF INVENTION

The present invention relates to a system and method for providing integrated software platform and more particularly for integrating various software functionalities on to a single hardware platform for cross transference of data in a network.

### BACKGROUND

In the first place, there is no integrated software platform available in the world that is designed holistically to cater to and link with all possible Planning, Execution, Operational and Control mechanisms of a business or enterprise. There is nothing available in the market that makes available on one single platform all of the various business processes named above in a manner that each process, while able to be run on stand-alone basis is simultaneously linked to and available from all other elements.

Essentially, the problems with current available products are that they function on stand-alone platforms and the present technology does not allow cross transference of data, replication within its design frame. Current products also do not provide for 360-degree user interface allowing the user to pull in any element that the user needs from a different module while simultaneously relating to different databases. Further, in the present technology for the transfer of data, a web page carries the data in the form of XML which means that data is carried along with definitions thus the size of the data being transferred is very high and it takes time to travel over the network.

The practices in vogue also entail challenges in the likes of an exploding increase in the number of users and database. The critical problems arise when the application throughout the system cannot access the data at the primary site where updates are necessary. Over and above this is the problem of platform dependency. It typically refers to applications that run under only one operating system and run in only one series of computers (one operating environment); for example, Windows running on x86 hardware or Solaris running on SPARC hardware. Also gigantic is the glitch of scalability wherein the software cannot handle growing amount of work. In web applications this is generally related to the increasing amount of web users or visitors. Alternatively this can be caused by an increasing amount of data. At some point one of the resources reaches hardware limits which are called—a bottleneck.

The instant invention redresses all of these problems in part and/or in entirely by providing a need of a system and method and provides a technique for seamless integration of multiple software functionalities in one platform and provides a 360 degree framework for all-operational and work parameters of an organization along with fast and efficient transfer of data in a network.

### SUMMARY

The primary objective of the present invention is to provide a system and method for integrating various software functionalities on to a single hardware platform for cross transference of data.

The present invention provides software linked to hardware devices that amalgamates and encompasses in a 360-degree frame all-operational and work parameters of a business or an organization. It ensures a smooth flow that interconnects all aspects of an organization's interdepartmental interface and functioning with the external sources outside the organization in an authenticated and controlled manner. The instant invention also provides for fast and efficient transfer of data over the network when a request for a web page is made by the client from the server.

### BRIEF DESCRIPTION OF DRAWINGS

FIG. 1 illustrates a system for a system for integrating software functionalities in a n-layer architecture platform.

FIG. 2 illustrates a diagrammatic representation of the authentication module used to establish and authenticate a session.

FIG. 3 illustrates a schematic representation of the replication module.

FIG. 4 illustrates a schematic diagram of data fetching process carried out in the search module and data flow basic data flow from client to server (database server) Using asynchronous request.

FIG. 5 illustrates an exemplary flowcharts of transfer of data when a request is made to a server by a client according to the prior art and the present invention respectively.

FIG. 6 gives us an insight into the comparative study of between the performance of traditional application module and Ajax application module.

### DETAILED DESCRIPTION

System and method for providing integrated software platform is described. Exemplary embodiments of the present invention are now described with reference to the accompanying drawings.

The instant invention provides a system and method for integrating various software functionalities to hardware devices that amalgamates and encompasses in a 360-degree frame all-operational and work parameters of a business or organization. It teaches a method and a system for integrating software functionalities in a n-layer architecture platform, the method comprising authenticating a session, basic and advanced replication of a master database onto a slave database, fetching the related information from the master database; and updating the slave database. The method and the system thus establish an incoming session, assign a token to that session, submit an authentication command; and terminate the client session. The token is updated if the entity issuing the command and accessing the resources is authenticated. The assigned token is then updated else the unused assigned token is returned error. The method and the system also espouse for fetching related information from the master database constituting reading configuration file of the server processes, and retrieving the last date of access and data set for a particular web service, processing and pushing tables in a list of tables.

The integration allows various departments with their interconnected linkages within the organization to Plan, Operate and Execute in a holistic 360-degree frame. Various nominated staff can input into and access permitted sections of the system, have linkages and conversations within defined pre-set limits. The system also allows interface, limited or total as required, with third parties or external entities within defined system limits through authentication in a controlled manner to specific areas of the software system as per a given need. The instant invention provides a major improvement to any existing stand-alone products or processes. It provides efficient and seamless business functioning by combining in one platform, the following functionalities with major improvements.
Enterprise Resource Management (ERM)
Enterprise Resource Planning and Management (ERP)
Customer Relations Management (CRM)
Relational Database Management System (RDBMS)
   Cluster, replication, backup and recovery system,
Software as a Service (SAAS),
   Real time intelligent interaction with human clients
Statistical Analysis System (SAS),
Target Setting & Performance Analysis System (TSPAS),
Event Planning & Management System (EPMS),
Marketing, Planning & Execution System (MPES)
Management Information System (MIS),
Centralized Administrative Model (CAM),
Content Management System (CMS),
Human Resource Management System (HRMS)
Quality Control & Management (QCM)
Integrating Telecom Traffic (ITT)—In process
Invoicing, Payments & Stock Management System (ISMS) to seamlessly integrate with the Accounts Department and Accounting software, the field operations as it relates to selling of products and stock control of the Organization
Communications Management System (CMS)
Meeting Management System

These functionalities are available across departments and any or all of the organization's various operating divisions. For example, the Marketing department would access the Planning Screen, define the Planning area, choose the product or service demographics, enter the strategic plan, associated costs and get a holistic result that is then visible to all selected staff anywhere in the world who can then see elements relevant to them, input into them and implement the final approved plan, monitor the progress of implementation by revenue and deadlines targets etc. The frame is then also available to related departments, for e.g. the Operations department can input into or factor the marketing plan within their own operational framework. Designated individuals are able to access their areas or roles and responsibilities to implement and monitor their own progress. Team leaders and managers are able to view and input into their individual roles and responsibilities as related to the planning and execution exercise.

The Customer Service Executive is able to track a customer from the point of enquiry to completion, regardless of the number of staff that have interacted with the customer, on a single or multiple transactions, thus enabling the organization to maximize its Customer Service & Satisfaction, which in turn is enabled to be monitored through system and method of the instant invention. Similar ease of operation-ability is available across the organization's divisions or departments.

The organization operates on a central server environment with multiple branch network, management needs, operation-ability, scalability, robustness and integrated efficient management frameworks that evolved in real time settings and implication. On addition of more servers to the organization infrastructure, the capacity of supporting n number of users is further increased. The system can operate on Linux, Windows and Macintosh or any other operating systems available in the market. It is not dependent on operating systems (OS). The instant invention also allows for monitoring and assessing past performance indicators, plans set by head office and execution success frames at regional office or branch office or division and then allows these elements to be automatically updated within the chain of command to be made available to authorized personnel.

The instant invention is based on Ajax (asynchronous JavaScript and XML) which means a user can simultaneously send more than one request at a time (Common software accepts only one request at a time which means the user will be idle till the first request is processed). The instant invention provides a method that is based on Java Script Object Notation through which data is transferred at a very high rate and it takes less time to travel over the network.

The instant invention includes three separate geographic installations, fail-over between these main locations, and load balancing within each installation. LDAP (Lightweight Directory Access Protocol) replicas are placed at each installation, obtaining their information from a master LDAP at the main data center.

The present invention is not intended to be restricted to any particular form or arrangement, or any specific embodiment, or any specific use, disclosed herein, since the same may be modified in various particulars or relations without departing from the spirit or scope of the invention herein above.

The following discussion provides a brief, general description of a suitable environment in which various embodiments of the present disclosure can be implemented. The aspects and embodiments are described in the general context of computer executable mechanisms such as routines executed by a general purpose computer e.g. a server or personal computer. The embodiments described herein can be practiced with other system configurations, including internet appliances, hand held devices, multi-processor systems, microprocessor based or programmable consumer electronics, network PCs, mini computers, mainframe computers and the like. The embodiments can be embodied in a special purpose computer or data processor that is specifically programmed configured or constructed to perform one or more of the computer executable mechanisms explained in detail below.

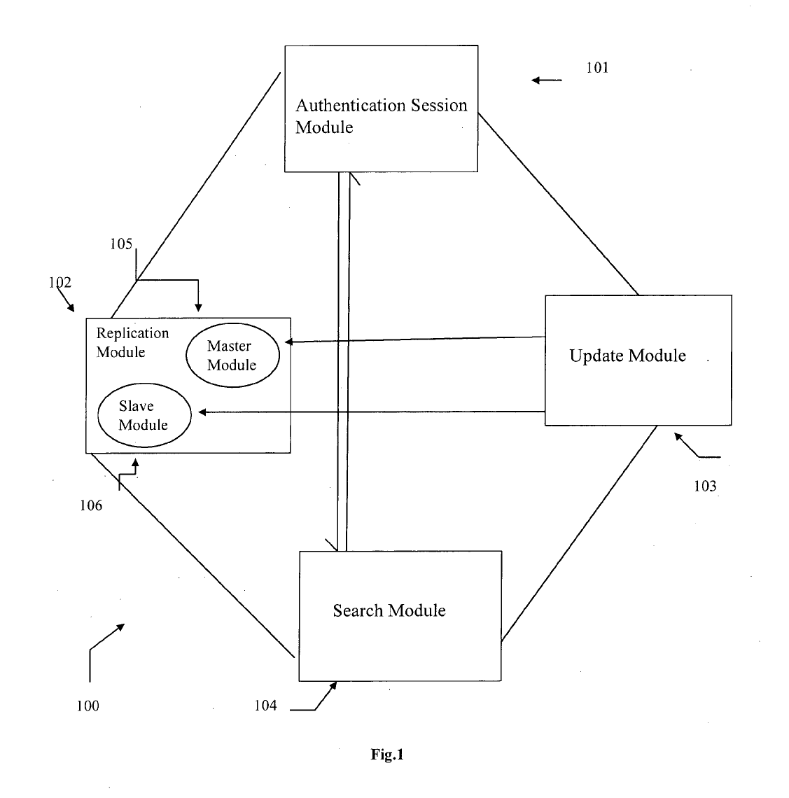

FIG. 1 illustrates a system for a system for integrating software functionalities in a n-layer architecture platform, the system comprising an authentication session module (101), a replication module (102), a search module (104); and an update module (103).The authentication module (101) is coupled to the search module (104). A master module (105) and a slave module (106) reside inside the replication module (102). The update module (103) is connected to the master module (105) and the slave module (106) (also referred to here as master database and slave database respectively) residing inside the replication module (104).

In another embodiment of the invention the authentication does the work of establishing and authenticating a session (200). The replication module does the work of copying the master database into the slave database. The search module processes and adds the required tables (400). The update module updates the slave module (106) after gaining inputs from the master module (105).

In yet another embodiment of the invention the desired features and parameters of the master module (105) and slave module (106) are extracted to from a master table module and a slave table module.

The subsequent description will elucidate more on these modules.

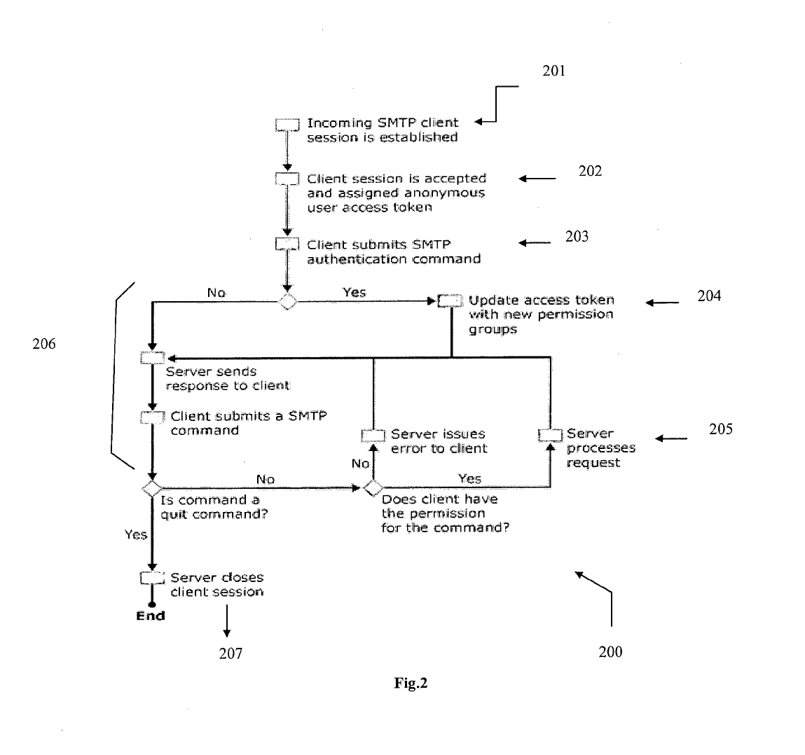

FIG. 2 shows a diagrammatic representation of the authentication module used to establish and authenticate a session (200). The incoming request from the end user (201) is established. On initializing the session a toke is assigned to the user (202) post which the user submits his command to perform a task (203). If the command and the task to be performed meet the tenets of authentication the access token in updated, the request is processed. (204,205). If the command is unauthenticated then the unused token is returned (206). The session is terminated once it is authenticated (207).

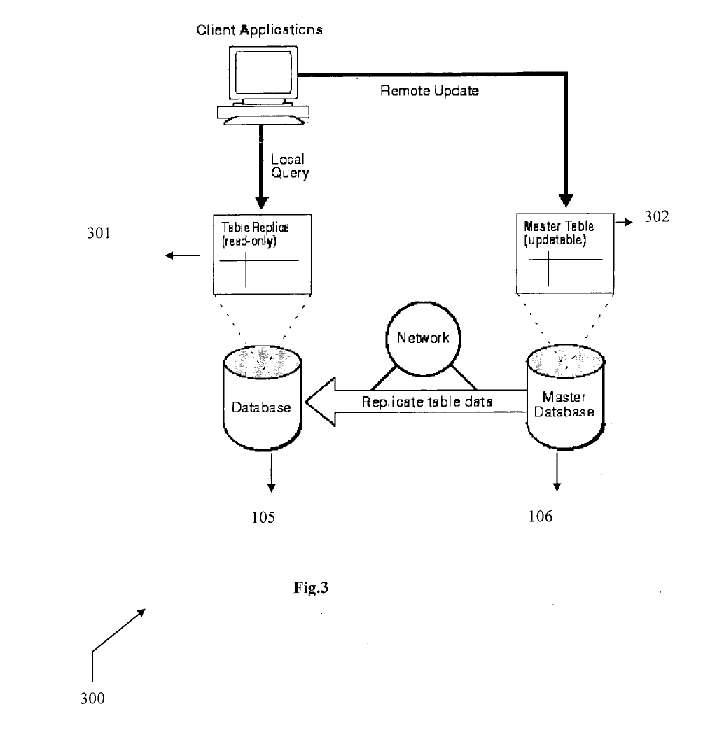

FIG. 3 illustrates a schematic representation (300) of the replication module (102). The master module also known as master database (105) and the slave module also known as slave databases (106) reside inside it. The desired features are extracted from the master module (105) and the slave module (106) to form a mater table module (301) and slave table module (302) respectively. The replication is done using the concept of ‘connection pooling’ wherein we only we require separate connection to achieve this if primary server has trouble in connecting. Connection, pooling is a technique that the application software manages the connections; connection is always persistent in nature.

Pooling objects is an optimization that is widely adopted in many scenarios. Pooling an object makes sense if the object:
is required for a relatively short duration
is expensive to create every time it is required
is expensive to maintain all the time (even when not required) because it consumes resources.

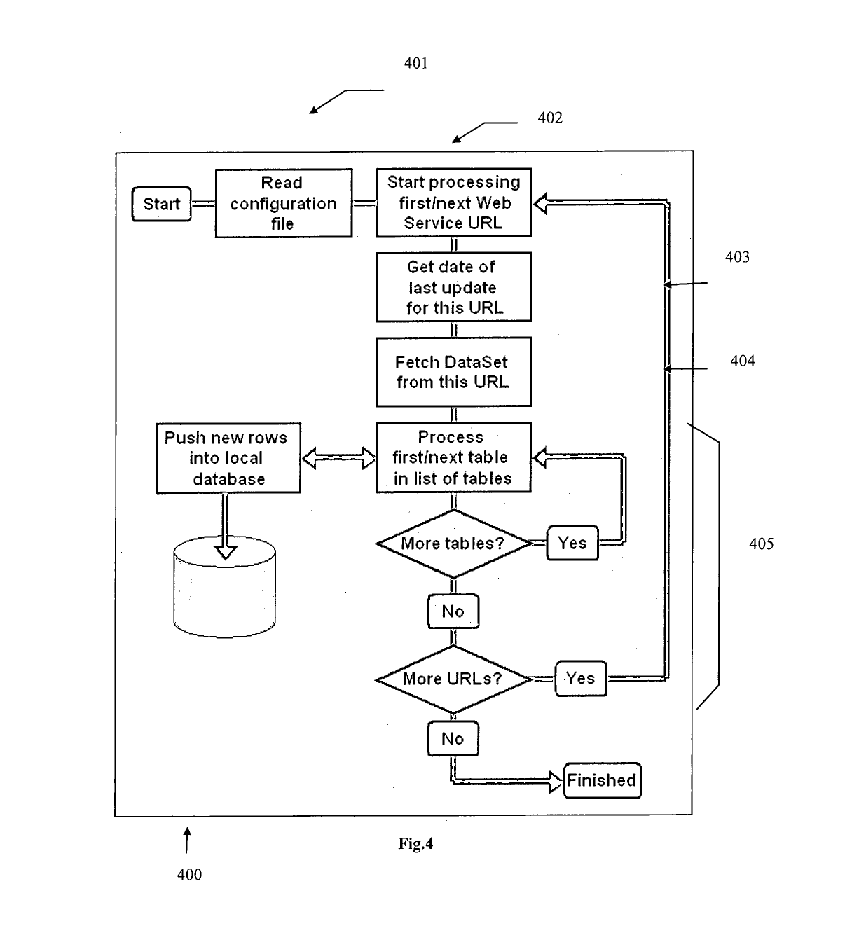

FIG. 4 illustrates a schematic diagram of data fetching process (400) carried out in the search module (104). It depicts data flow basic data flow from client to server (database server) Using asynchronous request.

In another embodiment of the invention the functional units of the file according to their nature, number and chief characteristics are read (401). The files web service is processed; the last access date of the web service is retrieved (402, 403 and 404). The hence fetched files are processed and pushed (405) into the existing slave module (106).

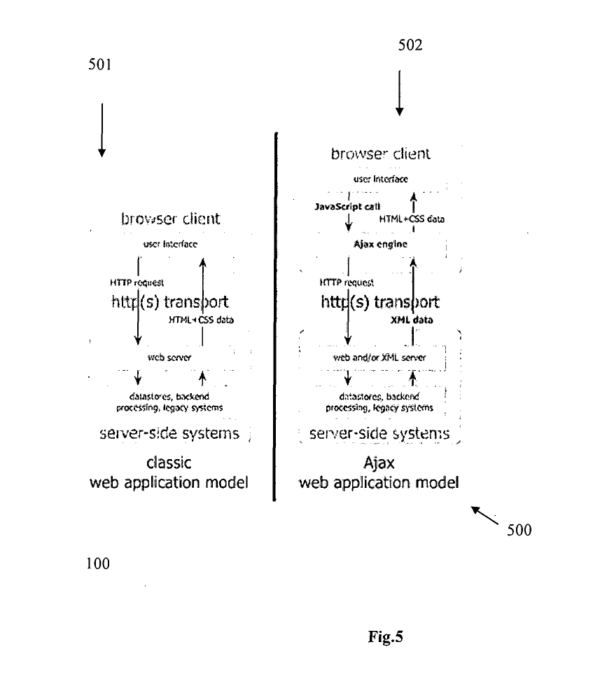

FIG. 5 illustrates the Ajax web application module (502) in contrast with the classic web application module (501). It employs the technique of JavaScript object notation (JSON). Normally all data travel is in the format of XML (which is heavyweight because of its tag). Alternatively JSON format is used for data travelling which is very rare in use.

In another embodiment of the invention, more responsive applications can improve productivity not just by reducing ‘wait’, but by promoting a more fluid, uninterrupted workflow. In a responsive application, users can move rapidly from one action to another as quickly as they can visualize the workflow.

In yet another embodiment of the invention the Ajax applications reduce the amount of time your page or application must wait for data to be processed. An AJAX call is much faster than a complete, top-to-bottom page reload. Since page load time and response time are a problem for everyone that wants to provide a good user experience. It also cuts down on the amount of bandwidth. Again, reloading an entire page can consume more bandwidth than using AJAX since in theory the browser will be requesting more information from the web server when reloading an entire page than it would when simply sorting a table.

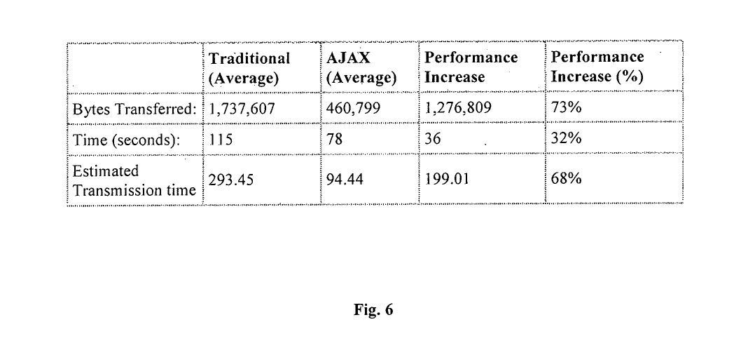

FIG. 6 gives us an insight into the comparative study of between the performance of traditional application module and Ajax application module.

The present invention is not to be limited in scope by the specific embodiments and examples which are intended as illustrations of a number of aspects of the invention and any embodiments which are functionally equivalent are within the scope of this invention. Those skilled in the art will know, or be able to ascertain using no more than routine experimentation, many equivalents to the specific embodiments of the invention described herein. These and all other equivalents are intended to be encompassed by the following claims.

1. A method for integrating software functionalities in n-layer architecture platform, the method comprising:
(I) authenticating a session;
(II) basic and advanced replication of a master database onto a slave database;
(III) fetching the related information from the master database; and
(IV) updating the slave database.

2. The method as claimed in claim 1, wherein the n-layer architecture platform comprises a client tier, a middle tier and a data source tier.

3. The method as claimed in claim 1, wherein the master database is a primary database which records the existence of all other databases, the location of these databases files and the initialization information of the server.

4. The method as claimed in claim 1, wherein the slave database is a local database, the existence and the location of which is recorded in the master database.

5. The method as claimed in claim 3, wherein the desired parameters of the master database are extracted to form a master table.

6. The method as claimed in claim 4, wherein the desired parameters of the slave database are extracted to form a slave table.

7. The method as claimed in claim 1, wherein the step of authenticating a session comprises:
(A) establishing an incoming session;
(B) assigning a token to that session;
(C) submitting an authentication command; and
(D) terminating the client session.

8. The method as claimed in claim 7, wherein the assigned token is updated depending upon the command accessing an authenticated data.

9. The method as claimed in claim 7, wherein an error is returned along with the unused token depending if the command was accessing an unauthenticated data.

10. The method as claimed in claim 1, wherein the step of basic and advanced replication of master database onto the slave database employs connection pooling.

11. The method as claimed in claim 10, wherein the connection pooling involves a client access to the updated slave table regardless of the network availability to the master table.

12. The method as claimed in claim 1, wherein the step of fetching related information from the master database comprises:
(E) reading configuration file of the server processes;
(F) retrieving the last date of access and data set for a particular web service; and,
(G) processing and pushing tables in a list of tables.

13. A system for integrating software functionalities in a n-layer architecture platform, the system comprising:
(I) an authentication session module;
(II) a replication module coupled to a master module and a slave module;
(III) a search module; and
(IV) an update module.

14. The system as claimed in claim 13, wherein the n-layer architecture platform comprises:
(A) a client tier,
(B) a middle tier; and
(C) a data source tier.

15. The system as claimed in claim 13, wherein the master module is a primary module which records the existence of all other sub modules, the location of these module files and the initialization information of the server.

16. The system as claimed in claim 13, wherein the slave module is a local module, the existence and the location of which is recorded in the master module.

17. The method as claimed in claim 15, wherein the desired parameters of the master module are extracted to form a master table module.

18. The method as claimed in claim 16, wherein the desired parameters of the slave module are extracted to form a slave table module.

19. The system as claimed in claim 13, wherein the authentication session module is configured:
(I) to establish an incoming session;
(II) to assign a token to that session;
(III) submit an authentication command; and
(IV) terminate the client session.

20. The system as claimed in claim 19, wherein the assigned token is updated depending upon the command accessing the authenticated data.

21. The system as claimed in claim 19, wherein an error is returned along with the unused token depending if the command was accessing unauthenticated data.

22-25. (canceled)
